(19) United States
(12) Patent Application Publication
(10) Pub. No.: US 2023/0109640 A1
(43) Pub. Date: Apr. 6, 2023

(54) SKELETON DETECTION SYSTEM AND WORK MANAGEMENT DEVICE

(71) Applicants: DAICEL CORPORATION, Osaka (JP); HITACHI, LTD., Tokyo (JP)

(72) Inventors: Yasutsugu Toyoda, Tokyo (JP); Yasuhiko Inadomi, Tokyo (JP); Yuki Ishito, Tokyo (JP); Toshihiro Yamada, Tokyo (JP); Hiroshi Yoshikawa, Tokyo (JP)

(73) Assignees: DAICEL CORPORATION, Osaka (JP); HITACHI, LTD., Tokyo (JP)

(21) Appl. No.: 18/079,231

(22) Filed: Dec. 12, 2022

Related U.S. Application Data
(63) Continuation of application No. PCT/JP2021/004032, filed on Feb. 4, 2021.

(30) Foreign Application Priority Data
Jun. 12, 2020 (JP) 2020-101986

(51) Int. Cl. G06T 7/246; G06V 40/20; G06T 7/00

(52) U.S. Cl. CPC G06T 7/251; G06V 40/20; G06T 7/0004; G06V 2201/07; G06T 2207/30108; G06T 2207/10016

(57) ABSTRACT

A skeleton detection system includes, a first storage unit configured to store reference operation information related to at least one cycle of a reference operation being a repetitive operation performed by an operator, a skeleton information detection unit configured to detect skeleton information about the operator from a working video obtained by capturing the operator during work, and a target identification unit configured to identify, as a target, among pieces of skeleton information about a plurality of operators during work, detected by the skeleton information detection unit, skeleton information about an operator indicating an operation satisfying a target requirement that a difference between the reference operation information and inspection target information being operation information during work falls within a preset allowable operation range.

### TECHNICAL FIELD

The present disclosure relates to a skeleton detection system and a work management device.

### BACKGROUND ART

A method for inspecting work performed by an operator by an inspection system using a computer is known. In this method, as described in, for example, Patent Document 1, image data obtained by capturing an operator during work is analyzed by the computer, and behavior of the operator appearing in the image data is compared with a determination reference to determine whether the operator appropriately performs the work.

### CITATION LIST

### Patent Document

Patent Document 1: JP 2011-048547 A

### SUMMARY

However, in the method disclosed in Patent Document 1, when a plurality of operators are captured at the same time in image data, for example, an operator to be inspected may be mistakenly recognized as another operator by the computer, depending on a change in the behavior of the operator. Further, a load on the inspection system may be increased depending on a capacity and the like of image data used in an inspection.

Therefore, the present disclosure has an object to reduce a load of information processing in a system for detecting a skeleton of an operator when work of the operator is inspected by an inspection system by using image data obtained by capturing the operator during the work, and the like.

In order to solve the problem described above, a skeleton detection system according to the present disclosure includes: a first storage unit configured to store reference operation information related to at least one cycle of a reference operation being a repetitive operation performed by an operator; a skeleton information detection unit configured to detect skeleton information about the operator from a working video obtained by capturing the operator during work; and a target identification unit configured to identify, as a target, among pieces of skeleton information about a plurality of operators during work, detected by the skeleton information detection unit, skeleton information about an operator indicating an operation satisfying a target requirement that a difference between the reference operation information and inspection target information being operation information during work falls within a preset allowable operation range.

The configuration described above can identify a target from the pieces of the skeleton information about the operators detected from the working video. In other words, a target can be identified by comparing the inspection target information about the operator with the reference operation information, about the operator, stored in the first storage unit. In particular, the skeleton detection system according to the present disclosure sets the repetitive operation of the operator as an inspection subject, and the operation of the operator to be inspected has regularity and periodicity. Thus, identification of the target can be accurately and quickly performed by using the skeleton detection system according to the present disclosure. Further, the operator to be inspected can be identified from the operators captured in the video during work by identifying the target by the target identification unit. Thus, a load on the skeleton detection system can be reduced.

The present disclosure can appropriately inspect an operator and reduce a load of an inspection system, in a case where an operation of the operator is inspected by the inspection system using image data obtained by capturing an operator during work, even when a plurality of operators are captured at the same time in the image data.

### BRIEF DESCRIPTION OF DRAWINGS

FIG. 1 is a functional block diagram of a skeleton detection system according to a first embodiment.

FIG. 2 is a diagram illustrating skeleton information on a front side of an operator detected by a skeleton information detection unit illustrated in FIG. 1.

FIG. 3 is a diagram illustrating the skeleton information on a lateral side of the operator detected by the skeleton information detection unit illustrated in FIG. 1.

FIG. 4 is a flowchart of target identification processing of the skeleton detection system illustrated in FIG. 1.

FIG. 5 is a diagram schematically illustrating how a target is identified from data captured in a video during work in the target identification processing according to the first embodiment.

FIG. 6 is a diagram illustrating positional information on a front side of an operator included in skeleton information according to a third modified example.

FIG. 7 is a diagram illustrating positional information on the lateral side of the operator included in the skeleton information according to the third modified example.

FIG. 8 is a flowchart illustrating an overall operation of a skeleton detection system according to a fourth modified example.

FIG. 9 is a functional block diagram of a work management device according to a second embodiment.

FIG. 10 is a flowchart illustrating an overall operation of the work management device illustrated in FIG. 9.

FIG. 11 is a sub-flowchart of pass/fail determination processing illustrated in FIG. 10.

### DESCRIPTION OF EMBODIMENTS

Embodiments of the present invention will be described below with reference to the drawings.

### First Embodiment

### Skeleton Detection System

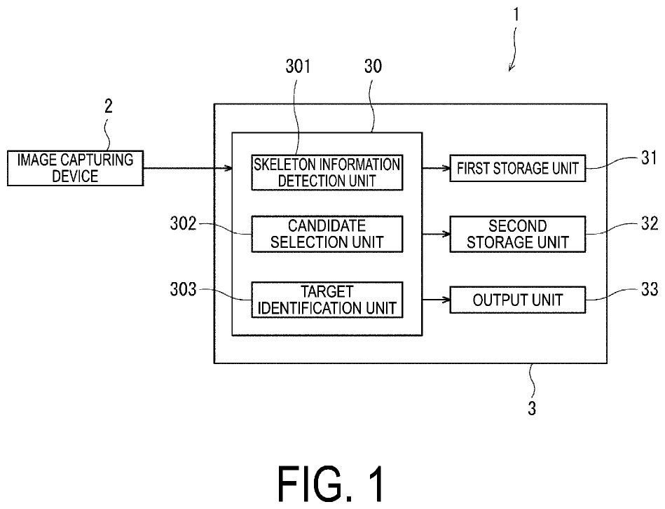

FIG. 1 is a functional block diagram of a skeleton detection system 1 according to a first embodiment. The skeleton detection system 1 is an inspection system for inspecting an operation of an operator. The skeleton detection system 1 detects skeleton information indicating the operation of the operator from a video during work (hereinafter, also simply referred to as a “working video”), obtained by capturing the operator during work. The skeleton information detected by the skeleton detection system 1 is used for an inspection of a repetitive operation performed by the operator during work. Examples of the repetitive operation to be inspected include assembly work of a product, but not limited thereto.

The skeleton detection system 1 includes an image capturing device 2 that captures a working video, and a detection device 3 that detects skeleton information from the working video. The image capturing device 2 is a video camera including an imaging element such as a CCD, for example, and generates a working video and outputs data of the working video. The image capturing device 2 is placed in a position where an operator during work can be captured. As an example, the image capturing device 2 is placed so as to capture a certain region of a workplace where an operator works. The image capturing device 2 and the detection device 3 are connected to each other in a wireless or wired manner.

The detection device 3 includes an arithmetic unit 30 that receives data of the working video output from the image capturing device 2, and a first storage unit 31, a second storage unit 32, and an output unit 33 that are individually controlled by the arithmetic unit 30. The first storage unit 31 stores reference operation information for at least one cycle of a reference operation that is obtained from the working video and is a repetitive operation performed by an operator. The reference operation is an operation being a model of the repetitive operation of the operator, and is set for each piece of work. The reference operation in the present embodiment may be set based on reference operations of a plurality of operators performing the same content work. For an example, the first storage unit 31 according to the present embodiment stores reference operation information about an operator, obtained from a reference video obtained by capturing a reference operation of the operator (hereinafter, also simply referred to as a reference video). For example, the reference video is a video obtained by capturing an operator in a state where an operation of the operator can be clearly confirmed (for example, a state where there is no obstacle between the operator and the image capturing device 2). The reference video includes the reference operation information corresponding to at least one cycle of the reference operation of the operator. Time for the one cycle of the reference operation is, for example, approximately several seconds to several minutes, but not limited thereto.

The second storage unit 32 stores inspection target information about at least one cycle of a repetitive operation (real operation) performed by an operator as an actual operation. The repetitive operation (real operation) is captured by the image capturing device 2. A post verification can be performed by storing the inspection target information about the repetitive operation (real operation) in the second storage unit 32. The information stored in the first storage unit 31 and the second storage unit 32 may be read to the arithmetic unit 30 at a predetermined timing, but the information stored in the first storage unit 31 and the inspection target information about the repetitive operation (real operation) captured by the image capturing device 2 can be read to the arithmetic unit 30 as appropriate. The output unit 33 outputs the information stored in the first storage unit 31 and the second storage unit 32. The output unit 33 is a display, for example.

For example, the detection device 3 is achieved by a computer including a processor such as a CPU, a recording medium such as a ROM, a RAM, and an HDD, and a display such as an LCD. The arithmetic unit 30 is achieved by the processor. The number of the processors may be either single or multiple. The first storage unit 31 and the second storage unit 32 are achieved by the recording medium described above. Furthermore, a program for the arithmetic unit 30 to execute each processing according to the present embodiment, and information about a candidate requirement and a target requirement, which will be described below, are stored in the recording medium described above. The recording medium described above may be an external storage device provided outside the detection device 3.

The arithmetic unit 30 includes a skeleton information detection unit 301, a candidate selection unit 302, and a target identification unit 303. The skeleton information detection unit 301 detects the skeleton information about the operator from the working video output from the image capturing device 2. A known method may be employed as a method for detecting the skeleton information. Examples of the method for detecting the skeleton information include a method using an “Open Pose” technique (see Zhe Cao, Tomas Simon, Shih-En Wei, Yaser Sheikh, “Realtime Multi-Person 2D Pose Estimation using Part Affinity Fields”, arXiv:1611.08050v2) being published by Carnegie Mellon University and being an open source library that can detect positions of a plurality of persons in a capturing image after recording or in real time. Even when the bodies of a plurality of operators overlap one another in the working video, the method can distinguish and detect skeleton information about each of the operators.

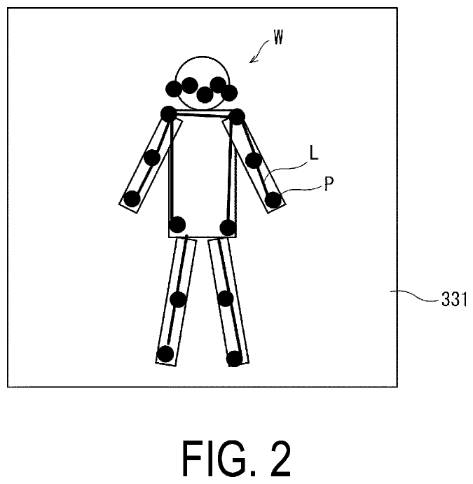

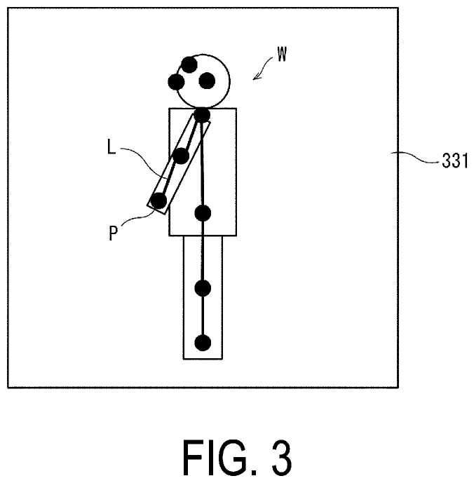

FIG. 2 is a diagram illustrating skeleton information on the front side of an operator W detected by the skeleton information detection unit 301 in FIG. 1. FIG. 3 is a diagram illustrating the skeleton information on the lateral side of the operator W detected by the skeleton information detection unit 301 in FIG. 1. FIGS. 2 and 3 schematically illustrate a state when the skeleton information about the operator W is displayed on a display surface 331 of the output unit 33. Further, in addition to FIGS. 2 and 3, FIG. 5 described below schematically illustrates the skeleton information about the operator W, and also illustrates a predetermined position of the skeleton information by a black circle.

As illustrated in FIGS. 2 and 3, as an example, the skeleton information is information about at least any of positions of a plurality of portions P of the operator W, a length of a line L that connects two or more portions (for example, a joint portion and the like) of the plurality of portions P of the operator W, or a skeleton shape formed of the plurality of portions P and the line L. The information includes positional information about two-dimensional coordinates. The skeleton information changes according to a posture of the operator W in the working video. The arithmetic unit 30 recognizes the change in the skeleton information across a plurality of successive frames included in the working video.

The candidate selection unit 302 selects a candidate that satisfies a predetermined candidate requirement from a plurality of pieces of the skeleton information about a plurality of the operators W detected from the working video. In this way, the candidate selection unit 302 narrows down the number of the operators W to be inspected. The candidate requirement is preset as requirements for the candidate selection unit 302 to narrow down targeted skeleton information from the plurality of pieces of the skeleton information in the working video. In such a manner, the candidate selection unit 302 uses the candidate requirement to narrow down the skeleton information captured in the working video, thereby reducing a burden on the skeleton detection system 1.

Here, as an example, the candidate requirement according to the present embodiment includes a condition that the skeleton information is located in a predetermined region in a capturing range indicated by the working video. Examples of the predetermined region include a center region in the working video, a region of at least one side of left and right sides, or a work region of the operator W (as an example, a region including a work desk and its vicinity), but not limited thereto. According to such a candidate requirement, by setting the predetermined region described above, the candidate selection unit 302 can select a candidate having a high possibility of being a target from the plurality of pieces of the skeleton information in the working video, and can further reduce a burden on the skeleton detection system 1.

The target identification unit 303 identifies, as the target, the skeleton information about the operator W indicating the operation that satisfies the target requirement. The target requirement described above is a requirement that a difference between the reference operation information and the inspection target information falls within a preset allowable operation range, among pieces of the skeleton information about the plurality of operators W during the work detected by the skeleton information detection unit 301. When the difference between the inspection target information and the reference operation information about the candidate (operator W) detected by the candidate selection unit 302 satisfies the target requirement described above, the target identification unit 303 identifies the candidate as the target. Note that, in the present embodiment, when the target identification unit 303 determines that there is no target, the candidate selection unit 302 selects another candidate that satisfies the candidate requirement. The candidate selection unit 302 and the target identification unit 303 repeat the same processing until the target is determined.

The allowable operation range described above (operation range that satisfies the target requirement) can be set as appropriate. Examples of the allowable operation range include a range in which a positional deviation amount of a predetermined position (as an example, a position of either hand) in the skeleton information between the reference operation information and the inspection target information during the one cycle of the repetitive operation is less than a predetermined distance, and a range in which a positional deviation amount of an orbit drawn by the predetermined position during one cycle of the repetitive operation is less than a predetermined distance. Alternatively, the examples of the allowable operation range include a range in which a deviation time of the operation for at least a part of one cycle of the repetitive operation of the skeleton information is less than a predetermined time. Note that a case where the time required for the operation is too short with respect to the predetermined time may also be excluded from the allowable operation range. Thus, the predetermined time is set according to a work content.

The target identification unit 303 according to the present embodiment calculates the difference between the reference operation information and the inspection target information in a state where the reference operation information and the inspection target information are synchronized. Specifically, the target identification unit 303 matches start times of the repetitive operation indicated in the reference operation information and the inspection target information by setting, as a reference time, a timing at which the skeleton information about a predetermined position of a body of an operator included in the inspection target information matches the skeleton information about a predetermined position of a body of an operator included in the reference operation information within a certain range (for example, a range in which a positional deviation falls within several centimeters). Then, the target identification unit 303 calculates the difference between the reference operation information and the inspection target information during at least one cycle of the repetitive operation after the reference time. The difference may be, for example, a maximum positional deviation amount of the skeleton information about the predetermined position of the body of the operator included in the reference operation information and the inspection target information when the start times of the operation is matched, a maximum positional deviation amount of an orbit drawn by the skeleton information about the predetermined position of the body of the operator included in the reference operation information and the inspection target information when the start times of the operation is matched, or a deviation amount of a period of the operation between the reference operation information and the inspection target information.

### Operation of Skeleton Detection System

At a time of an operation of the skeleton detection system 1, first, the arithmetic unit 30 performs target identification processing of identifying a target from the plurality of pieces of the skeleton information about the plurality of operators W in the working video. In the target identification processing according to the present embodiment, first, the skeleton information detection unit 301 detects the skeleton information about the operator W from the working video. Then, the candidate selection unit 302 selects a candidate from pieces of the detected skeleton information to narrow down the number of the operators W to be inspected. Subsequently, the target identification unit 303 identifies an inspection target from the selected candidates. In this way, the target identification processing is performed. The arithmetic unit 30 repeatedly performs the flow of the present processing unless an inspector instructs to stop an inspection.

In such a manner, the skeleton detection system 1 according to the present embodiment can identify a target from the pieces of the skeleton information about the operators W detected from the working video. In other words, a target can be identified by comparing the inspection target information about the operator W with the reference operation information about the operator W stored in the first storage unit 31. In particular, the skeleton detection system 1 sets the repetitive operation of the operator W to be inspected, and the operation of the operator W to be inspected has regularity and periodicity. Thus, identification of the target can be accurately and quickly performed by using the skeleton detection system 1. Further, the operator W to be inspected can be identified from the operators W captured in the working video by identifying the target by the target identification unit 303. Thus, a load on the skeleton detection system 1 can be suppressed.

Further, the first storage unit 31 stores the reference operation information about the operator W obtained from the reference video. Therefore, the arithmetic unit 30 can use the reference operation information at any time by referring to the first storage unit 31. Thus, the arithmetic unit 30 refers to the reference operation information according to the timing required by the arithmetic unit 30, and thus an inspection of the repetitive operation of the target can be efficiently performed.

Further, the skeleton detection system 1 according to the present embodiment includes the second storage unit 32 that stores the inspection target information. Therefore, the arithmetic unit 30 can use the inspection target information at any time by referring to the second storage unit 32. Thus, for example, even after the operator W has performed the repetitive operation, the arithmetic unit 30 refers to the inspection target information according to the timing required by the inspector or the arithmetic unit 30, and thus a post inspection of the repetitive operation of the target can be performed.

Further, the target identification unit 303 according to the present embodiment identifies, as the target, the skeleton information about the operator W indicating the operation that satisfies the target requirement. In such a manner, by using the target requirement, the target identification unit 303 can stably identify the skeleton information about the operator W to be identified as the target.

Further, as an example, the skeleton information includes data of at least any of positions of the plurality of portions P of the operator W, a length of the line L that connects two or more portions of the plurality of portions P of the operator W, or a skeleton shape formed of the plurality of portions P and the line L. In such a manner, the skeleton information is body information in which the body of the operator W is simplified to an extent that the repetitive operation can be recognized, and thus has a smaller amount of information than that of image data itself of the operator W, for example. Thus, the arithmetic unit 30 can accurately perform an inspection of the repetitive operation of the target, based on the skeleton information including such data, while reducing a work burden.

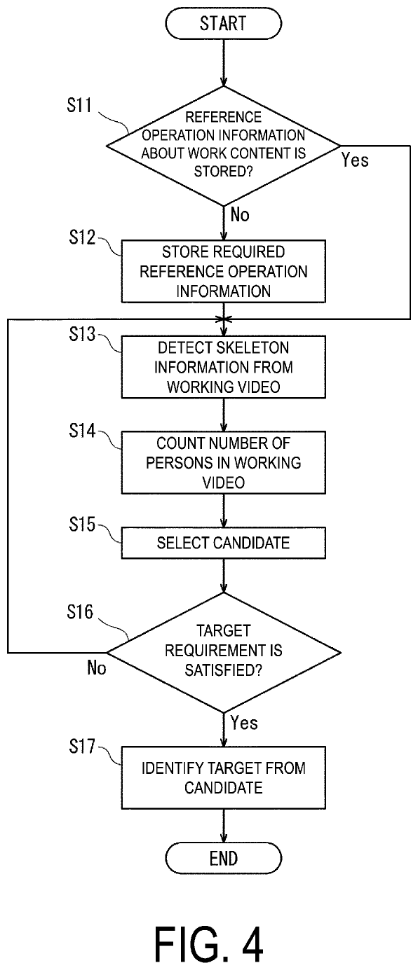

Hereinafter, a specific content of the target identification processing according to the present embodiment will be exemplified. FIG. 4 is a flowchart of the target identification processing of the skeleton detection system 1. The flow illustrated in FIG. 4 is the target identification processing according to the present embodiment. In the present flow, first, the arithmetic unit 30 determines whether reference operation information about a work content is stored in the first storage unit 31 in the skeleton detection system 1 (step S11). When the arithmetic unit 30 determines that the reference operation information about the work content is not stored in the first storage unit 31 in step S11 (step S11: No), the arithmetic unit 30 acquires necessary reference operation information and stores the reference operation information in the first storage unit 31 (step S12), and then the step proceeds to step S13. When the arithmetic unit 30 determines that the reference operation information about the work content is stored in the first storage unit 31 in step S11 (step S11: Yes), the step proceeds to step S13.

In step S12, the arithmetic unit 30 may inform an inspector that the reference operation information about the work content is insufficient through, for example, the output unit 33, and may prompt the inspector to input data of a reference video including the necessary reference operation information to the detection device 3. When the arithmetic unit 30 detects that the inspector inputs the data of the reference video to the detection device 3, the skeleton information detection unit 301 may detect skeleton information as the reference operation information about the operator W from the data of the reference video.

Next, the skeleton information detection unit 301 detects the skeleton information about the operator W from the working video in which the operator W during the work is captured (step S13). Then, the arithmetic unit 30 counts the number of the operators W captured in the working video, based on the skeleton information detected by the skeleton information detection unit 301 (step S14).

Then, the candidate selection unit 302 selects a candidate that satisfies a candidate requirement from pieces of the skeleton information about the operators W detected from the working video (step S15). In this way, the pieces of the skeleton information as an inspection subject are further narrowed down. As an example, the candidate requirement in the present flow includes a condition that the skeleton information is located in a predetermined region in a capturing range indicated by the working video. The predetermined region can be set as appropriate, but can be set to, for example, a work region in which the operator W works (as an example, a region including a work desk and its vicinity). Alternatively, the predetermined region may be set in a center region of the working video, for example. In this way, the skeleton information about the operator W located in the predetermined region among the operators W captured in the working video is selected as the candidate.

Next, the target identification unit 303 determines whether the candidate selected in step S15 satisfies a target requirement (S16). When the target identification unit 303 determines that the candidate does not satisfy the target requirement in step S16 (step S16: No), the step returns to step S13. When the target identification unit 303 determines that the candidate satisfies the target requirement in step S16 (step S16: Yes), the step proceeds to step S17.

In step S17, when one candidate is determined to satisfy the target requirement in step S16, the target identification unit 303 identifies this candidate as the target. In step S17, when a plurality of candidates are determined to satisfy the target requirement in step S16, the target identification unit 303 identifies, as the target, a candidate with the smallest deviation in the allowable operation range of the target requirement among the plurality of candidates. As an example, the arithmetic unit 30 stores an identification result of the target in the first storage unit 31. After step S17 is performed, the arithmetic unit 30 ends the present flow.

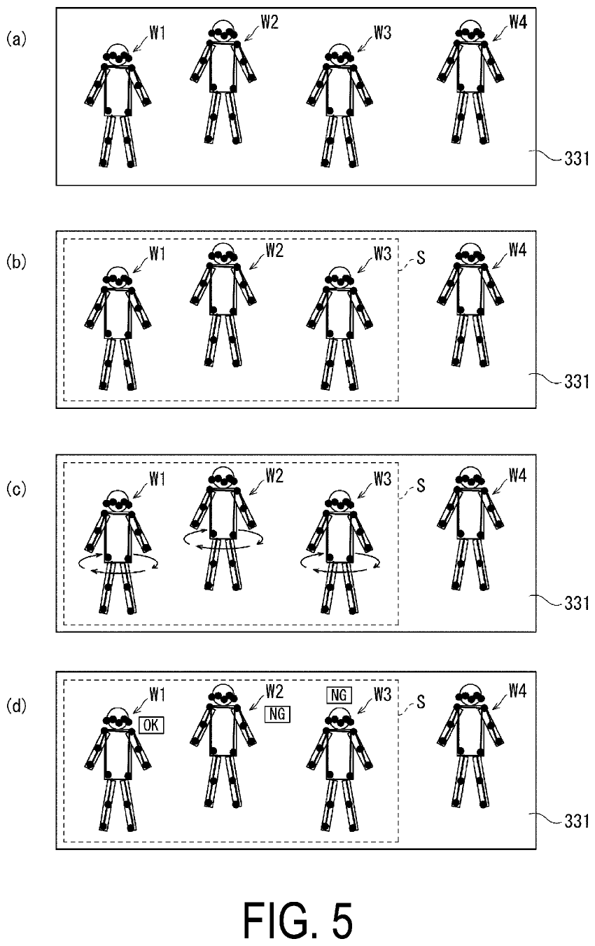

Here, FIGS. 5(a) to 5(d) are diagrams schematically illustrating a state until a target is identified from a working video in the target identification processing according to the first embodiment. In the example illustrated in FIG. 5, in step S13, pieces of skeleton information about four operators W1 to W4 are detected from a working screen by the skeleton information detection unit 301 (FIG. 5(a)). Further, in step S15, the pieces of the skeleton information about the three operators W1 to W3 located in a predetermined region S of the working video are selected as a candidate by the candidate selection unit 302 (FIG. 5 (b)). In this way, the skeleton information located outside the predetermined region S (here, the skeleton information about the operator W4) among the pieces of the skeleton information captured in a capturing region of the working video is not targeted for the candidate, and is excluded from the candidate.

Further, in step S17, the target identification unit 303 determines whether the pieces of the skeleton information about the operators W1 to W3 being the candidate satisfy a target requirement that a difference set for each work content, between reference operation information and inspection target information being operation information during work falls within a preset allowable operation range. As an example, the inspection target information about each of the operators is compared with the reference operation information in an order of W3, W2, and W1, and an operator (for example, W1) who satisfies the target requirement is identified as the target. Further, the pieces of the skeleton information about the operators W2 and W3 determined not to satisfy the target requirement are not a subject of the target, and are excluded from the target (FIGS. 5(c) and 5(d)).

According to the present embodiment, all the reference operation information required for an operation inspection of the operator W is stored in the first storage unit 31. Thus, in the present flow, information to be targeted is extracted from all the reference operation information stored in the first storage unit 31, and the skeleton information detected from the working video is compared with the reference operation information to identify a target. Thus, an inspection without an omission can be achieved. Further, a candidate is selected by the candidate selection unit 302 based on the candidate requirement including the condition of being located in the predetermined region S in the capturing range indicated by the working video. Therefore, a load on the skeleton detection system 1 for selecting a candidate can be reduced. Thus, a target can be quickly identified.

Hereinafter, a modified example according to the present embodiment will be described. A candidate requirement according to a first modified example includes, as an example, a requirement that a difference between reference operation information and inspection target information on skeleton information detected from a working video falls within a preset allowable operation range. In such a manner, in the present modified example, a candidate is selected by the candidate selection unit 302 based on a repetitive operation of the skeleton information in the working video. In this way, according to the present modified example, the skeleton information in which a relatively appropriate repetitive operation is performed is selected as the candidate before the target identification unit 303 identifies a target. Therefore, an appropriate candidate can be accurately selected by the candidate selection unit 302, and a burden when the target identification unit 303 identifies a target can also be reduced.

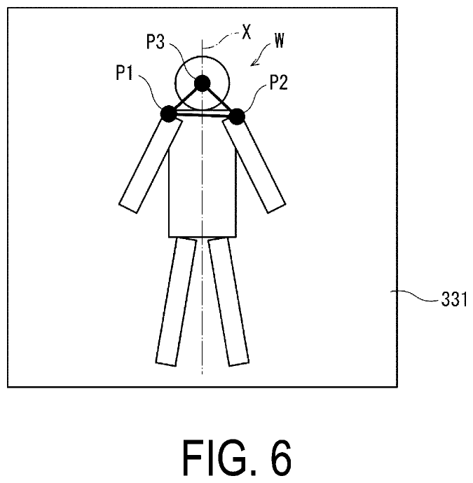

Further, the operator W to be inspected may work at a position closest to the image capturing device 2 among the plurality of operators W, for example. In this case, the operator W to be inspected is captured in the largest size in the working video among the plurality of operators W. Thus, a candidate requirement according to a second modified example includes, as an example, a condition that a size of a skeleton indicated by skeleton information detected from a working video is largest among the pieces of the skeleton information about the plurality of operators W detected from the working video. The size of the skeleton indicated by the skeleton information herein is represented by, for example, either an area of a polygon having, as vertexes, positions of three or more points of the body of the operator W (for example, an area of a triangle having, as vertexes, positions P1 to P3 illustrated in FIG. 6 below) detected from the working video, or a total skeleton length (for example, the line L illustrated in FIGS. 2 and 3) of the operator W detected from the working video. The polygon described above may have a shape having four or more vertexes. Further, an area of a polygon and a total skeleton length may be combined. The operator W captured in the largest state in the working video is selected as a candidate based on such a candidate requirement.

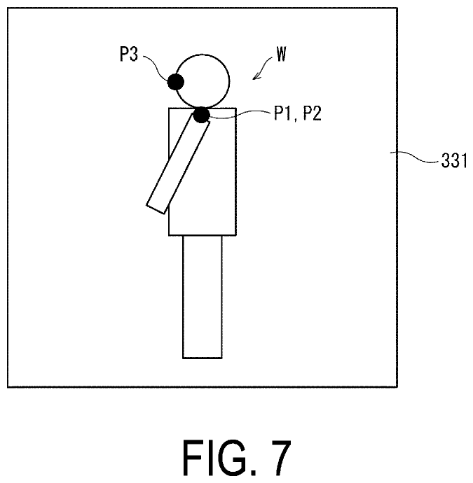

FIG. 6 is a diagram illustrating positional information on the front side of the operator W included in skeleton information according to a third modified example. FIG. 7 is a diagram illustrating the positional information on the lateral side of the operator W included in the skeleton information according to the third modified example. FIGS. 6 and 7 schematically illustrate the skeleton information displayed on the display surface 331 of the output unit 33.

As illustrated in FIGS. 6 and 7, the target identification unit 303 according to the third modified example identifies a target, based on an operation indicated by the skeleton information represented by a change in each of a first position P1 and a second position P2 (positions of a right shoulder and a left shoulder) separated on both sides sandwiching a center line X of the body of the operator W detected from a working video, and a third position P3 (center position of the head) separated from each of the first position P1 and the second position P2.

According to the present modified example, the target identification unit 303 identifies a target, based on skeleton information including relatively less positional information. Thus, as compared to, for example, a case where skeleton information about an entire body of the operator W is used, the target identification unit 303 can quickly identify the target, and can also further reduce a burden on the skeleton detection system 1 when the target is identified.

Further, in the present modified example, positional data of the first to third positions P1 to P3 is included in inspection target information. In this way, the target identification unit 303 can quickly identify a target from candidates based on the data of the first to third positions P1 to P3. Note that, in the first modified example, when the candidate selection unit 302 selects a candidate, the candidate selection unit 302 may select the candidate, based on an operation indicated by skeleton information represented by a change in each of the first to third positions P1 to P3.

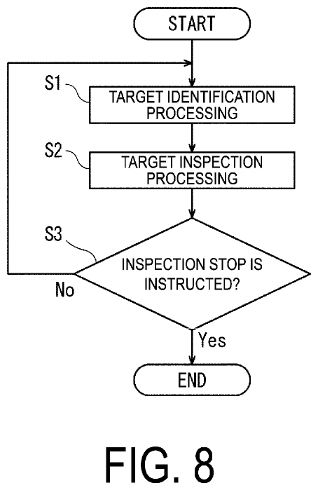

FIG. 8 is a flowchart illustrating an overall operation of a skeleton detection system according to a fourth modified example. The skeleton detection system according to the present modified example performs target identification processing (step S1), and then performs target inspection processing that inspects a repetitive operation of a target (step S2). After step S2, the arithmetic unit 30 determines whether there is an instruction to stop an inspection from an inspector (step S3). The skeleton detection system according to the present modified example repeatedly performs the flow of steps S1 to S3 as long as the arithmetic unit 30 determines that there is no instruction to stop the inspection from the inspector in step S3 (step S3: No). Note that the skeleton detection system according to the present modified example may include a recording unit that records a target inspection result. In this case, the arithmetic unit 30 records the target inspection result in the recording unit.

As an example, the skeleton detection system according to the present modified example performs the target identification processing (step S1) and the target inspection processing (step S2) in real time, based on a working video during capturing. In this way, the inspector can quickly inspect a repetitive operation of work of the operator Win real time by using the skeleton detection system. Thus, an inspection result can be immediately reflected in a current repetitive operation of the operator W. Further, the target inspection processing (step S2) is performed in real time, and thus, for example, even when an assembly that does not reach a quality reference due to an inappropriate operation of the operator W is assembled, the inspector can easily identify the assembly by using a device that analyzes an inspection result of the inspection processing. In this way, waste of an assembly can be reduced. In such a manner, according to the present modified example, various work analyses can be achieved by using an inspection result of the target inspection processing (step S2).

As in the present modified example, when the target inspection processing is performed in real time in the skeleton detection system, the arithmetic unit 30 may perform the target identification processing (step S1) and the target inspection processing (step S2) without storing a working video captured by the image capturing device 2 in the second storage unit 32, for example. Alternatively, the arithmetic unit 30 may perform the target identification processing (step S1) and the target inspection processing (step S2) while storing a working video captured by the image capturing device 2 in the second storage unit 32. Further, at least either a reference video or a working video may be recorded in a storage unit (for example, at least either the first storage unit 31 or the second storage unit 32) included in the skeleton detection system.

Next, a specific content of the target inspection processing (step S2) will be exemplified. In the present processing, as an example, the arithmetic unit 30 performs an operation inspection of a repetitive operation in the present operation, based on skeleton information in a working video, for a target (for example, W1) identified in step S17. The operation inspection is performed by, for example, the arithmetic unit 30 determining whether to satisfy a target inspection requirement that a difference between reference operation information and inspection target information falls within a preset allowable operation range. The allowable operation range of the target inspection requirement can be set to a range narrower than, for example, an allowable operation range of a target requirement, but not limited thereto.

According to the configuration described above, an inspector can appropriately and quickly perform an operation inspection on a repetitive operation of a target, based on an informed inspection result of the target. Hereinafter, a second embodiment will be described focusing on differences from the first embodiment.

### Second Embodiment

Hereinafter, a second embodiment will be described. The second embodiment exemplifies a device that performs processing similar to the target inspection processing according to the fourth modified example of the first embodiment described above, and performs processing of determining a pass or a fail of an operation of an operator corresponding to a target, based on an inspection result of the processing.

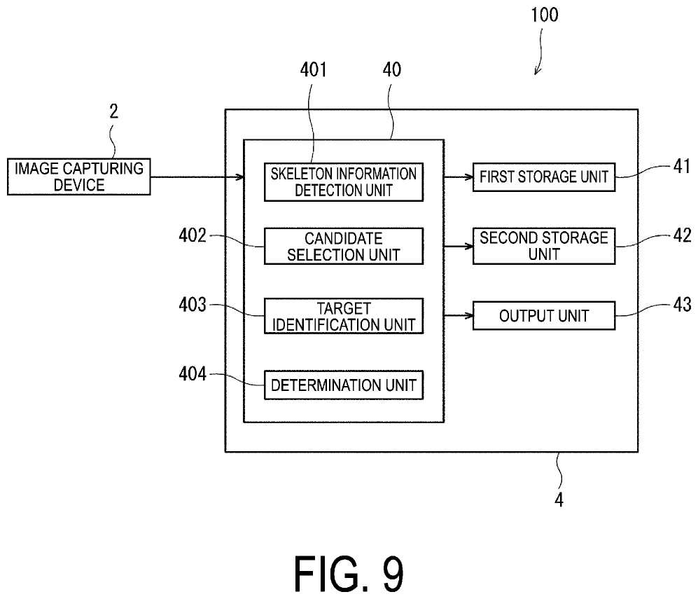

FIG. 9 is a functional block diagram of a work management device 100 according to the second embodiment. As illustrated in FIG. 9, the work management device 100 includes an image capturing device 2 and a determination device 4 to which the image capturing device 2 is connected. The determination device 4 includes an arithmetic unit 40, a first storage unit 41, a second storage unit 42, and an output unit 43. The arithmetic unit 40 includes a determination unit 404 in addition to a skeleton information detection unit 401, a candidate selection unit 402, and a target identification unit 403. The determination unit 404 performs pass/fail determination that determines a pass or a fail of an operation of an operator corresponding to a target at a predetermined timing, based on whether a difference between inspection target information about the target and reference operation information corresponding to the target falls within a preset reference range. The output unit 43 outputs a determination result of the pass/fail determination processing performed by the determination unit 404. In such a manner, the work management device 100 substantially has a configuration including the skeleton detection system 1 according to the first embodiment and the determination unit 404.

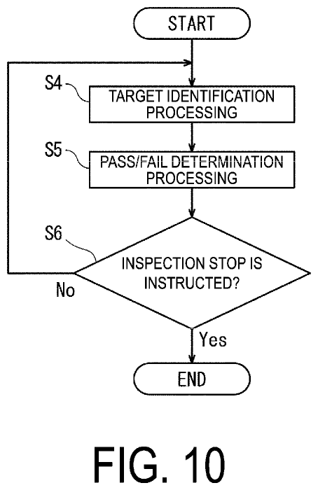

FIG. 10 is a flowchart illustrating an overall operation of the work management device 100 in FIG. 9. Hereinafter, the overall operation of the work management device 100 will be described by using FIG. 10. As illustrated in FIG. 10, at a time of the operation of the work management device 100, first, target identification processing is performed by the arithmetic unit 40 similarly to step S1 (step S4). Then, the determination unit 404 determines whether a difference between inspection target information about a target and reference operation information corresponding to the target falls within a preset reference range. In this way, the pass/fail determination processing is performed (step S5).

Next, the arithmetic unit 40 determines whether there is an instruction to stop an inspection from an inspector (step S6). When the arithmetic unit 40 determines that the inspection is instructed to stop from the inspector in step S6 (step S6: Yes), execution of the present flow is stopped. When the arithmetic unit 40 determines that the inspection is not instructed to stop from the inspector in step S6 (step S6: No), the step returns to step S4. In this way, the arithmetic unit 40 repeatedly performs the present flow unless the inspection is instructed to stop from the inspector. The overall operation of the work management device 100 has been described above.

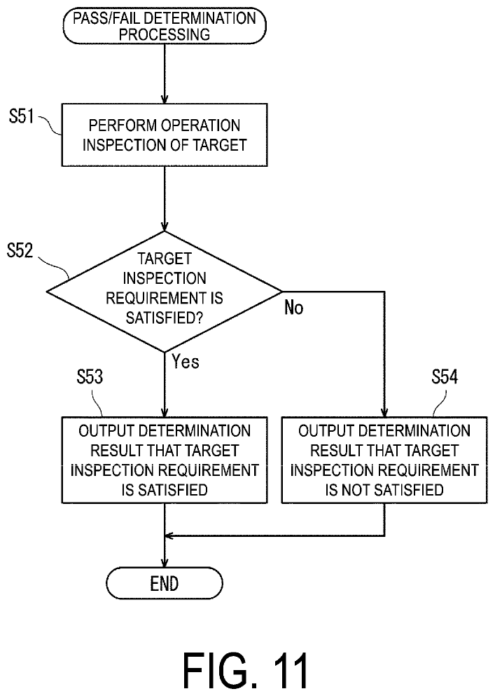

Hereinafter, a specific processing content in the pass/fail determination processing (step S5) in FIG. 10 will be exemplified. FIG. 11 is a sub-flowchart of the pass/fail determination processing in FIG. 10. In the present sub-flow, the arithmetic unit 40 performs an operation inspection of a repetitive operation of an identified target (step S51). As described above, in the operation inspection, the determination unit 404 determines whether a difference between inspection target information about the target and reference operation information corresponding to the target falls within a preset reference range (as an example, an allowable operation range of a target inspection requirement described above).

Next, the arithmetic unit 40 determines a pass or a fail of an operation of an operator corresponding to the target, based on whether the difference measured in the inspection result in step S51 falls within the reference range (step S52). When the difference in the inspection result in step S51 does not fall within the reference range (here, the target inspection requirement is not satisfied), and thus the arithmetic unit 40 determines that the operation of the operator corresponding to the target does not satisfy the reference in step S52 (step S52: No), the arithmetic unit 40 causes the output unit 43 to output a determination result indicating the determination (step S54), and ends execution of the present flow. When the difference in the inspection result in step S51 falls within the reference range (here, the target inspection requirement is satisfied), and thus the arithmetic unit 40 determines that the operation of the operator corresponding to the target satisfies the reference in step S52 (step S52: Yes), the arithmetic unit 40 causes the output unit 43 to output a determination result indicating the determination (step S53), and ends the execution of the present flow.

The work management device 100 that performs such an operation also achieves an effect similar to that of the skeleton detection system 1 according to the first embodiment. Since the arithmetic unit 40 includes the determination unit 404, an inspector can confirm, through a content output from the output unit 43, a determination result determined by the determination unit 404 for a repetitive operation indicated by a target. In this way, the inspector can reduce an inspection burden of performing an operation inspection on his/her own. Further, the inspector can stably and accurately inspect a repetitive operation of an operator W even for a long time.

Note that the output unit 43 may be a sound output unit. In this case, when the arithmetic unit 40 determines that the difference in an inspection result in step S51 does not fall within the reference range (step S52: No), the arithmetic unit 40 may cause the output unit 43 to output a warning sound in step S54. Further, the work management device 100 may include a recording unit that records a determination result of the determination unit 404. In this case, the arithmetic unit 40 records, in the recording unit, a determination result of the determination unit 404 obtained in step S52.

Note that each of the configurations, combinations thereof, or the like in each of the embodiments are examples, and additions, omissions, replacements, and other changes to the configurations may be made as appropriate without departing from the spirit of the present disclosure. The present disclosure is not limited by the embodiments and is limited only by the claims. Each aspect disclosed in the present specification can be combined with any other feature disclosed herein.

The skeleton detection system 1 and the work management device 100 may include a plurality of the image capturing devices 2. In this case, the skeleton detection system 1 and the work management device 100 can inspect a repetitive operation of the operator W at a plurality of places, for example.

Further, the first embodiment exemplifies the example of sequentially determining a plurality of candidates to identify a target, but a plurality of candidates may be simultaneously determined to identify a target. In this case, the skeleton detection system 1 may include, for example, a plurality of the arithmetic units 30.

### REFERENCE SIGNS LIST

W, W1 to W4 Operator
1 Skeleton detection system
31, 41 First storage unit
32, 42 Second storage unit
43 Output unit
100 Work management device
301, 401 Skeleton information detection unit
302, 402 Candidate selection unit
303, 403 Target identification unit
404 Determination unit

1. A skeleton detection system, comprising:
a first storage unit configured to store reference operation information related to at least one cycle of a reference operation being a repetitive operation performed by an operator;
a skeleton information detection unit configured to detect skeleton information about the operator from a working video obtained by capturing the operator during work; and
a target identification unit configured to identify, as a target, among pieces of skeleton information about a plurality of operators during work, detected by the skeleton information detection unit, skeleton information about an operator indicating an operation satisfying a target requirement that a difference between the reference operation information and inspection target information being operation information during work falls within a preset allowable operation range.

2. The skeleton detection system according to claim 1, wherein
the first storage unit stores the reference operation information, about the operator, obtained from a reference video obtained by capturing a reference operation of the operator.

3. The skeleton detection system according to claim 2, further comprising:
a second storage unit configured to store the inspection target information.

4. The skeleton detection system according to claim 1, further comprising:
a candidate selection unit configured to select a candidate satisfying a predetermined candidate requirement from the pieces of skeleton information about the plurality of operators detected from the working video, wherein
the target identification unit identifies, as the target, skeleton information about an operator selected by the candidate selection unit, indicating an operation satisfying a target requirement that a difference between the reference operation information and the inspection target information about the operator falls within a preset allowable operation range.

5. The skeleton detection system according to claim 4, wherein
the candidate requirement includes a condition that a size of a skeleton indicated by the skeleton information detected from the working video is largest among the pieces of skeleton information about the plurality of operators detected from the working video.

6. The skeleton detection system according to claim 5, wherein
the size of the skeleton indicated by the skeleton information is represented by either an area of a polygon with vertexes positioned at three or more points of a body of the operator detected from the working video, or a total skeleton length of the operator detected from the working video.

7. The skeleton detection system according to claim 4, wherein
the candidate requirement includes a condition that the skeleton information is located in a predetermined region in a capturing range indicated by the working video.

8. The skeleton detection system according to claim 1, wherein
the target identification unit identifies the target, based on an operation indicated by the skeleton information represented by a change in each of a first position and a second position separated on both sides sandwiching a center line of a body of the operator detected from the working video, and a third position separated from each of the first position and the second position of the body.

9. The skeleton detection system according to claim 8, wherein
the positional data of the first position to the third position in the working video is included in the inspection target information.

10. The skeleton detection system according to claim 1, wherein
the skeleton information includes data indicating a position of at least either of a plurality of portions of the operator or a line that connects two or more portions of the plurality of portions of the operator.

11. A work management device, comprising:
the skeleton detection system according to claim 1;
a determination unit configured to perform pass/fail determination that determines a pass or a fail of an operation of the operator corresponding to the target, based on whether a difference between the inspection target information indicated by the target and the reference operation information corresponding to the target falls within a preset reference range; and
an output unit configured to output a result of the determination by the determination unit.

12. The skeleton detection system according to claim 2, further comprising:
a second storage unit configured to store the inspection target information.

13. The skeleton detection system according to claim 2, further comprising:
a candidate selection unit configured to select a candidate satisfying a predetermined candidate requirement from the pieces of skeleton information about the plurality of operators detected from the working video, wherein
the target identification unit identifies, as the target, skeleton information about an operator selected by the candidate selection unit, indicating an operation satisfying a target requirement that a difference between the reference operation information and the inspection target information about the operator falls within a preset allowable operation range.

14. The skeleton detection system according to claim 3, further comprising:
a candidate selection unit configured to select a candidate satisfying a predetermined candidate requirement from the pieces of skeleton information about the plurality of operators detected from the working video, wherein
the target identification unit identifies, as the target, skeleton information about an operator selected by the candidate selection unit, indicating an operation satisfying a target requirement that a difference between the reference operation information and the inspection target information about the operator falls within a preset allowable operation range.

15. The skeleton detection system according to claim 2, wherein
the target identification unit identifies the target, based on an operation indicated by the skeleton information represented by a change in each of a first position and a second position separated on both sides sandwiching a center line of a body of the operator detected from the working video, and a third position separated from each of the first position and the second position of the body.

16. The skeleton detection system according to claim 4, wherein
the target identification unit identifies the target, based on an operation indicated by the skeleton information represented by a change in each of a first position and a second position separated on both sides sandwiching a center line of a body of the operator detected from the working video, and a third position separated from each of the first position and the second position of the body.

17. The skeleton detection system according to claim 5, wherein
the target identification unit identifies the target, based on an operation indicated by the skeleton information represented by a change in each of a first position and a second position separated on both sides sandwiching a center line of a body of the operator detected from the working video, and a third position separated from each of the first position and the second position of the body.

18. The skeleton detection system according to claim 7, wherein
the target identification unit identifies the target, based on an operation indicated by the skeleton information represented by a change in each of a first position and a second position separated on both sides sandwiching a center line of a body of the operator detected from the working video, and a third position separated from each of the first position and the second position of the body.

19. A work management device, comprising:
the skeleton detection system according to claim 2;
a determination unit configured to perform pass/fail determination that determines a pass or a fail of an operation of the operator corresponding to the target, based on whether a difference between the inspection target information indicated by the target and the reference operation information corresponding to the target falls within a preset reference range; and
an output unit configured to output a result of the determination by the determination unit.

20. A work management device, comprising:
the skeleton detection system according to claim 4;
a determination unit configured to perform pass/fail determination that determines a pass or a fail of an operation of the operator corresponding to the target, based on whether a difference between the inspection target information indicated by the target and the reference operation information corresponding to the target falls within a preset reference range; and
an output unit configured to output a result of the determination by the determination unit.
